(19) United States
(12) Patent Application Publication
(10) Pub. No.: US 2008/0148209 A1
(43) Pub. Date: Jun. 19, 2008

(54) Method of designing semiconductor integrated circuit using test point insertion adjustable to delay time

(75) Inventors: Toshiyuki Maeda, Kanagawa (JP); Toshiharu Asaka, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/000,429

(22) Filed: Dec. 12, 2007

(30) Foreign Application Priority Data
Dec. 19, 2006 (JP) 2006-340953

(51) Int. Cl. G06F 17/50

(52) U.S. Cl. 716/10

(57) ABSTRACT

A method of designing a semiconductor integrated circuit is based on a TPI (Test Point Insertion) technique. The design method includes: inserting a test point into a target node in a designed circuit and designating delay time for a test point path connected to the test point. Thereafter, a layout of a designed circuit is made so that delay time of the test point path becomes the above described designated delay time.

### BACKGROUND OF THE INVENTION

1. Field of the Invention

The present invention relates to design technologies of semiconductor integrated circuits. In particular, the present invention relates to design technologies of semiconductor integrated circuit with a Test Point Insertion method.

2. Description of Related Art

After manufacturing a semiconductor integrated circuit, it is necessary to carry out a test in order to confirm whether or not delay fault and stuck-at fault occur in the products. There are known design technologies for incorporating, in a design stage in advance, such a test circuit that can enhance testability at the time of the test. Such design technologies are called “DFT: Design For Testability”.

As a technique of Design For Testability, “scan design” is known (see, Patent Document 1 and Patent Document 2, for example). According to scan design, all or a part of flip-flops in a designed circuit are replaced by scan flip-flops. At the time of a test, those scan flip-flops can configure a scan path. Through the scan path, a test pattern is input and output and thereby a scan test is carried out. The test pattern is automatically generated by ATPG (Automatic Test Pattern Generator).

As a technique for improving testability, “TPI: Test Point Insertion” is known (see Patent Document 3 and Patent Document 4, for example). According to Test Point Insertion, in order to improve controllability and observability of signals at the time of a test, a test point is inserted into a node in a designed circuit.

In addition, currently, attention is focused on “small delay defect” (see Non-patent Document 1). Demands from the market for larger sizes and higher performance and making wiring and the gate fine with deep submicron process give rise to operation fault when slight deviation from a designed value is present in a critical path. That is, as a circuit becomes higher performance, larger and DSM, operation faults originated in small delay defect are increasing. In testing, it is important to detect small delay detects with high accuracy but without overlooking.

[Patent Document 1] Japanese Patent Laid-Open No. 2002-277515

[Patent Document 2] Japanese Patent Laid-Open No. 2006-4509

[Patent Document 3] Japanese Patent Laid-Open No. 2000-250946

[Patent Document 4] Japanese Patent Laid-Open No. 2005-135226

[Non-patent Document 1] Y. Sato, S. Hamada, T. Maeda, A. Takatori, Y. Nozuyama and S. Kajihara, “Invisible Delay Quality—SDQM Model Lights Up What Could Not Be Seen”, IEEE International Test Conference, Page 47. 1, Nov. 2005.

For conventional design technologies, the inventors of the application hereof focus attention on the following points.

FIG. 1 is a circuit diagram for describing the problems of the present invention and exemplifies a designed circuit based on a conventional scan design. A designed circuit illustrated in FIG. 1 includes flip-flops (scan flip-flops) FF1 to FF4. Delay time of a path P1 from the flip-flop FF1 to the flip-flop FF3 is 6 ns. Delay time of a path P2 from the flip-flop FF1 to the flip-flop FF4 is 8 ns. Delay time of a path P3 from the flip-flop FF2 to the flip-flop FF3 is 3 ns. Delay time of a path P4 from the flip-flop FF2 to the flip-flop FF4 is 5 ns. The path with the maximum delay time among the paths P1 to P4 (hereinafter referred to as “the longest path”) is the path P2. Here, a small delay defect is taken to occur in the node TN illustrated in FIG. 1.

FIG. 2 illustrates corresponding relation between the paths used for delay test and the size of the overlooked small delay defect (t_{defect}). Here, the system clock cycle is 9 ns. Since delay time of the longest path P2 is 8 ns, occurrence of faults for smaller than 1 ns will not affect system operations. Such a fault that will not affect the system operations is called a timing redundant fault. In the case of using the path P1, with the size of the delay fault smaller than 3 ns, signals are transmitted within the clock period (9 ns). Accordingly, that delay fault will not be detected but will be overlooked in the delay test. For further details, in the case of using the path P1, the delay fault with the size of 1 ns to 3 ns will be overlooked. Similarly, in the case of using the path P4, the delay fault with the size of 1 ns to 4 ns will be overlooked. Similarly, in the case of using the path P3, the delay fault with the size of 1 ns to 6 ns will be overlooked. On the other hand, in the case of using the longest path P2, the delay fault will be detected normally and no overlook will take place.

Thus, in order not to overlook any small delay defect in the delay test, it is preferable to use a path which is as long as possible. For the examples illustrated in FIG. 1 and FIG. 2, it is preferable to use the longest path P2. However, it depends on ATPG which path is used for a delay test. In general a comparatively short path is apt to be used. Accordingly, probability of the small delay defect being overlooked is high. It is considered to improve ATPG so that the longest path is used. However, in order to realize fault detection with the longest path, the test pattern necessarily becomes extremely complicated. Such a test pattern is hardly generated. In addition, as the number of patterns increases, time required for a delay test increases to increase the test cost.

In addition, FIG. 3 exemplifies a designed circuit based on a conventional TPI technique. In FIG. 3, a test point TP (observation flip-flop) is inserted into the node TN in the designed circuit illustrated in FIG. 1. The path from the flip-flop FF1 to the test point TP will be hereinafter referred to as “test point path PT”. The test point path PT includes the node TN. In a delay test, that test point path PT is used.

In the conventional TPI technique, the test point TP is inserted only for improving observability and controllability. The test point path PT is sufficient if it fulfills the setup constraint and the hold constraint. In general, the test point path PT is designed short. Accordingly, in the most cases, the test point path PT will become shorter than the longest path P2. Accordingly, the probability of the small delay defect being overlooked is high.

As having been described above, in the conventional design technologies, the probability of the small delay defect being overlooked in a delay test was extremely high. A reason thereof is that the conventional design technologies did not handle detection of small delay defects. When a small delay defect is overlooked, the rate of defective occurrence on the market will increase. That will be lead to a drop in reliability of products.

### SUMMARY OF THE INVENTION

A method of designing a semiconductor integrated circuit includes: inserting a test point into a target node in a designed circuit and designating delay time for a test point path being a path connected to the test point. A layout of a designed circuit is then made so that delay time of the above described test point path becomes the above described designated delay time.

Thus, a delay time in the test point path can be designated actively. That is, the delay time in the test point path can be set to a size sufficient for detecting a small delay defect. For example, the delay time of the test point path is set so as to be the same as the delay time of the longest path among paths passing the target node. Otherwise, the delay time of the test point path is set so as to be the same as the clock cycle at the time of the delay test. Thereby, reduction in overlooking a small delay defect in the delay test will be feasible.

According to design technologies related to the present invention, active designation of delay time for the test point path is feasible. That is, the delay time in the test point path can be set to a size sufficient for detecting small delay defects. Consequently, occurrence of overlooking small delay defects in the delay test is reduced. Accordingly, the rate of defective occurrence on the market is reduced and product reliability increases.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a circuit diagram exemplifying a designed circuit based on a scan design of a related art.

FIG. 2 is a conceptual diagram for describing the problems of the related art.

FIG. 3 exemplifies a designed circuit based on a TPI technique.

FIG. 4 is a flow chart illustrating a method of designing semiconductor integrated circuits related to the present invention.

FIG. 5 is a circuit diagram exemplifying a first example of a designed circuit related to the present invention.

FIG. 6 is a circuit diagram exemplifying a second example of a designed circuit related to the present invention.

FIG. 7 is a circuit diagram exemplifying a third example of a designed circuit related to the present invention.

FIG. 8 is a circuit diagram exemplifying a fourth example of a designed circuit related to the present invention.

FIG. 9 is a circuit diagram exemplifying a fifth example of a designed circuit related to the present invention.

FIG. 10 is a block diagram illustrating a first embodiment of the present invention.

FIG. 11 is a diagram exemplifying a TPI result file.

FIG. 12 is a diagram exemplifying a TP delay designation file.

FIG. 13 is a block diagram illustrating a second embodiment of the present invention.

FIG. 14 is a block diagram illustrating a third embodiment of the present invention.

FIG. 15 is a block diagram illustrating a fourth embodiment of the present invention.

FIG. 16 is a block diagram illustrating a configuration of an LSI design system related to an embodiment of the present invention.

### DETAILED DESCRIPTION OF THE EXEMPLARY EMBODIMENT

### 1. Design Flow

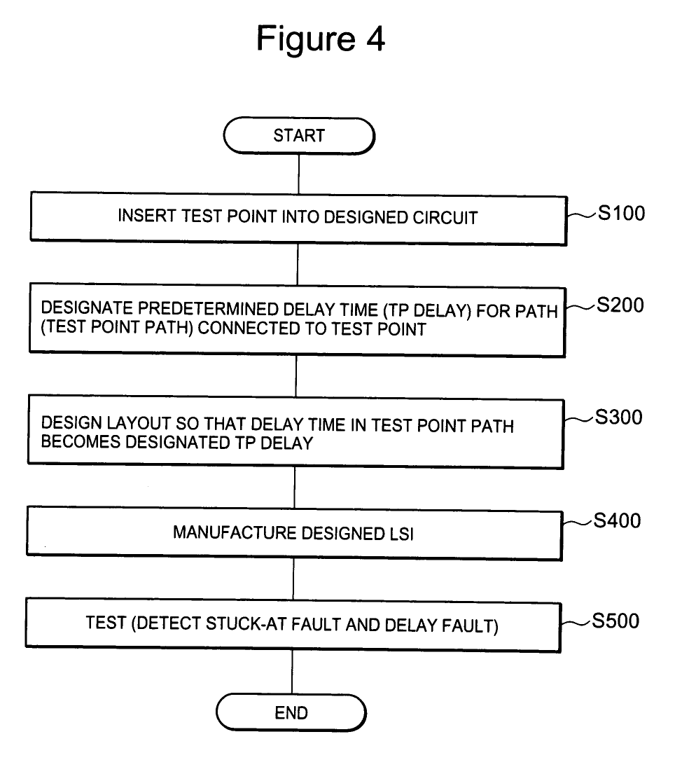

A method of designing semiconductor integrated circuits related to the present invention is basically based on the TPI technique. However, the TPI technique related to the present invention is different from a system and handles detection of small delay defects as well. At first, with reference to a flow chart illustrated in FIG. 4, a method of designing semiconductor integrated circuits related to the present invention will be looked down.

Step S100:

At first, a test point (control test point and/or observation test point) is inserted into a designed circuit. Specifically, a node, where signals are hardly controllable and observable, is searched through testability analysis and a test point is inserted into the found node (hereinafter referred to as “target node”). A method of determining the position (target node) where a test point should be inserted is similar to the related method. Signals in the target node where the test point is inserted are controllable and observable from the outside. As the test point, for example, flip-flops allowing scan tests are used.

Step S200:

Next, for a path connected to the test point, a predetermined delay time is designated. The path connected to the test point is a path starting at the control test point or ending at the observation test point and hereinafter referred to as “test point path”. In addition, the delay time designated for the test point path will be hereinafter referred to as “TP delay”.

Step S300:

Next, the designed circuit undergoes layout process. Here, according to the present invention, the layout process is carried out so that the delay time of the test point path will be the above described designated TP delay. In the related TPI technique, the test point path PT, for which only the setup constraint and the hold constraint are considered, is sufficient if those constraints are fulfilled. However, in the present invention, delay time of the test point path is designated. The test point path is designed so as to realize that designated delay time. Consequently, layout data in consideration of the designated TP delay is prepared.

Step S400:

Based on the prepared layout data, semiconductor integrated circuit being the designed object is manufactured.

Step S500:

A test of the manufactured semiconductor integrated circuit is executed. For the test, the above described inserted test point is used and presence of a stuck-at fault and a delay fault will be examined. In particular, presence of a small delay defect is examined through the delay test with the test point. In order to reduce occurrence of overlooking small delay defects in the delay test, according to the present invention, the above described “TP delay” is set as described below.

### 1-1. First Example

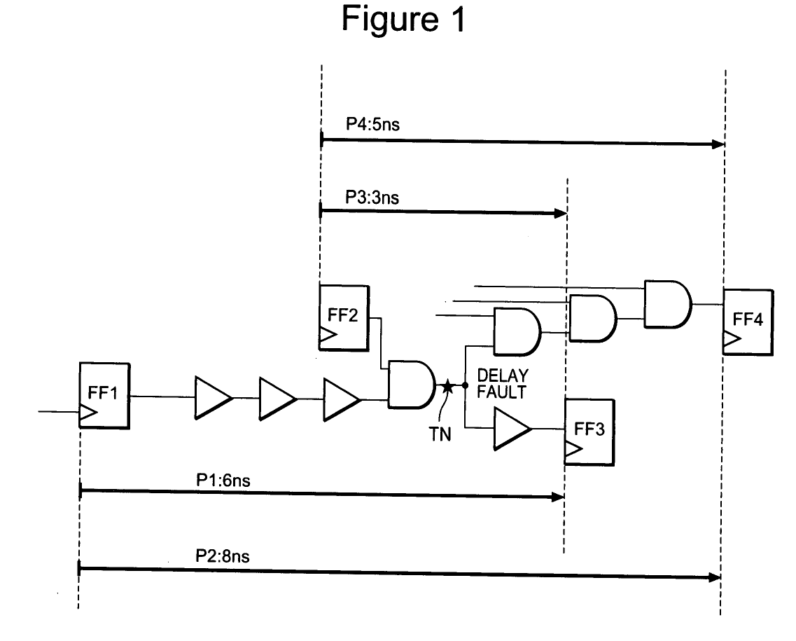

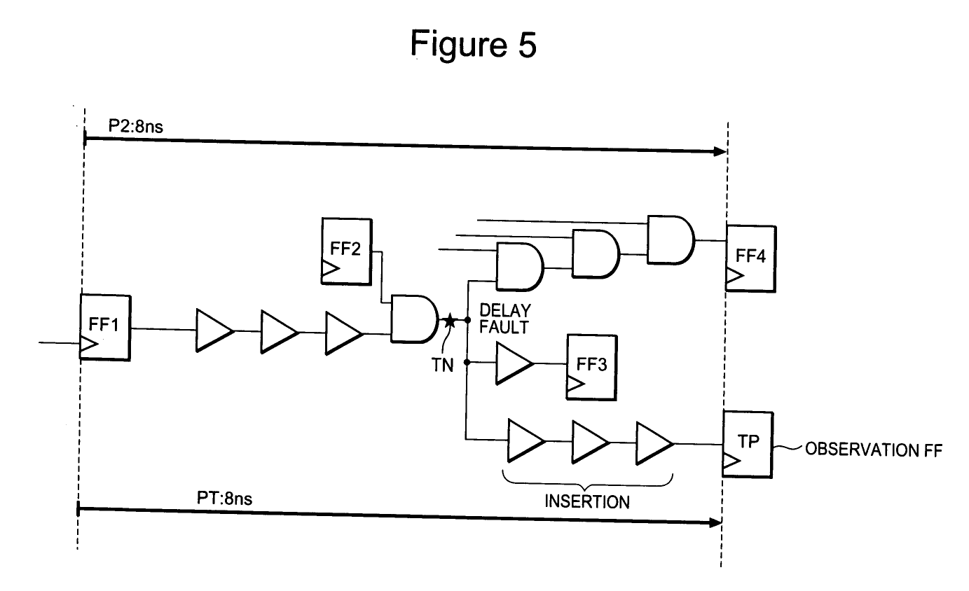

FIG. 5 illustrates a first example of a designed circuit related to the present invention. The designed circuit illustrated in FIG. 5 includes flip-flops (scan flip-flops) FF1 to FF4 similarly to the one illustrated in FIG. 1. In addition, in FIG. 5, the test point TP (observation flip-flop) is inserted into a target node TN in the designed circuit. A path from the flip-flop FF1 to the test point TP is the test point path PT. The longest path with the delay time being the maximum among the paths passing the target node TN besides the test point path PT is a path P2 (delay time: 8 ns) from the flip-flop FF1 to the flip-flop FF4.

In the step S200, the TP delay is designated for the test point path PT. In the first example, delay time of the longest path P2 is designated as the TP delay. That is, the TP delay is set so as to be the same as the delay time of the longest path P2 being the path which is preferably used in the delay test. The TP delay is the maximum of the delay time of the paths passing the target node TN. In the step S300, timing design for the test point path PT is implemented so that the designated TP delay is realized. Therefore, as illustrated in FIG. 5, several inverters are inserted as delay elements. Consequently, a test point path PT with the delay time being 8 ns is obtained.

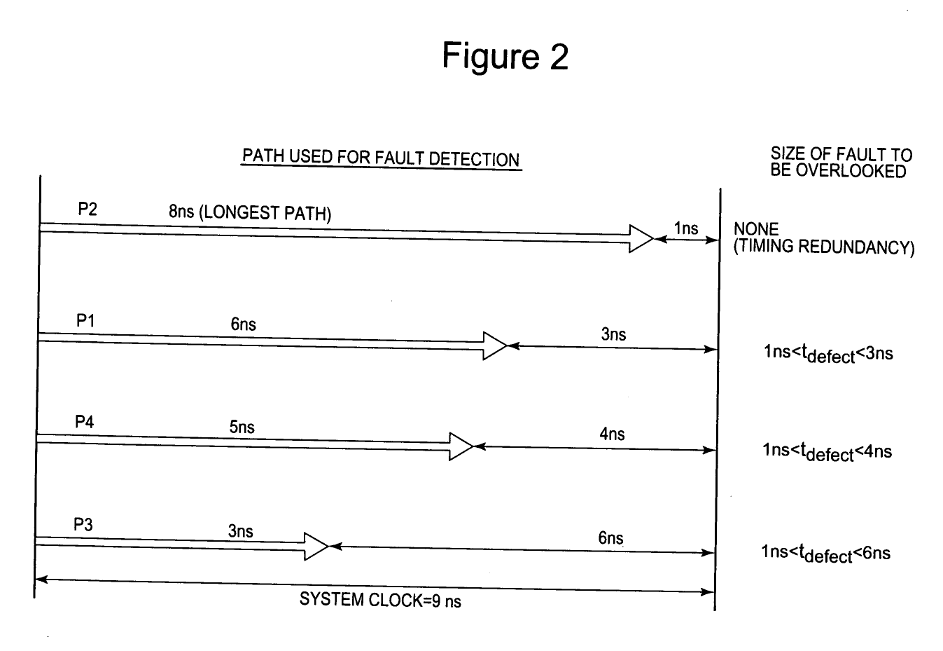

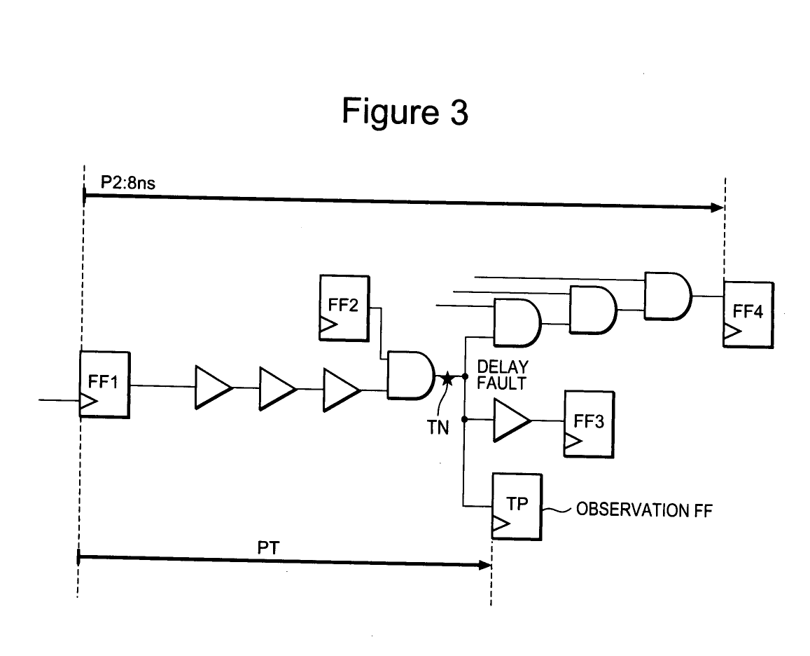

In the step S400, a semiconductor integrated circuit is manufactured. At that occasion, a small delay defect is taken to occur in the target node TN. In the step S500, a delay test with the test point path PT is carried out. At that occasion, the delay time of the test point path PT is 8 ns. Therefore, a small delay defect is not overlooked but is detected normally (see FIG. 2). Thus, even if designing is carried out based on the TPI technique, no small delay defect is overlooked in the delay test. Since overlooking of the small delay defect decreases, the rate of defective occurrence is reduced.

### 1-2. Second Example

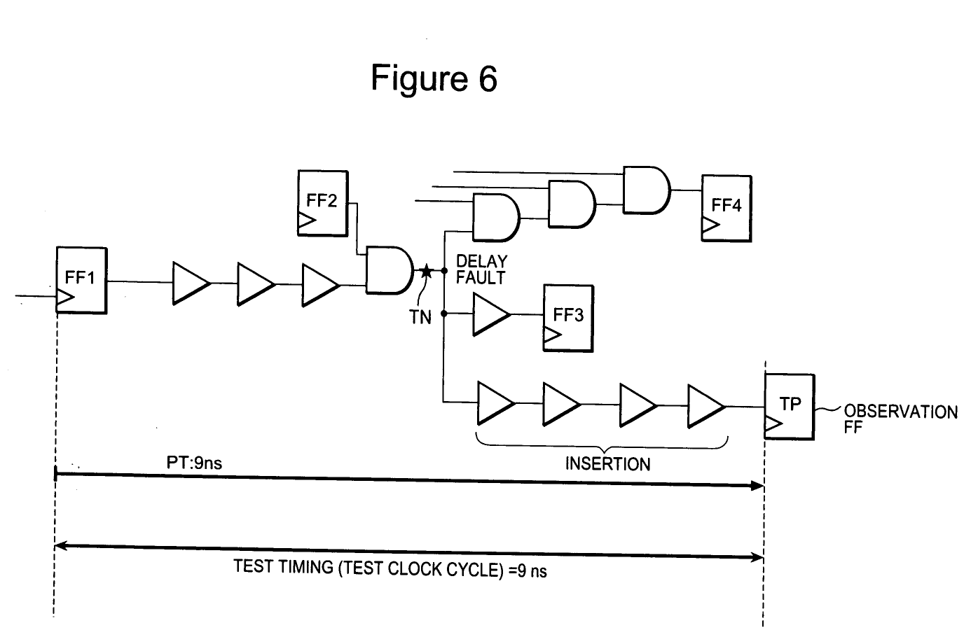

FIG. 6 illustrates a second example of the designed circuit related to the present invention. Description overlapping with description in the first example will be omitted appropriately. In the second example, the test clock cycle (test timing) at the time of delay test is designated as the TP delay. In the present example, the test clock cycle is 9 ns. The TP delay is also set likewise to 9 ns. The TP delay is the maximum of the delay time of the paths passing the target node TN. As illustrated in FIG. 6, several inverters are inserted as delay elements so that the designated TP delay is realized. Consequently, a test point path PT with the delay time being 9 ns is obtained.

In the delay test, the test point path PT is used. Accordingly, even if a small delay defect has occurred at the target node TN, the small delay defect is not overlooked but is detected normally. That is, the same effects as in the first example are obtained. Moreover, according to the second example, the TP delay is set to a value (maximum value) larger than that in the case of the first example. Therefore, accuracy in detecting the small delay defect is improved further.

### 1-3. Third Example

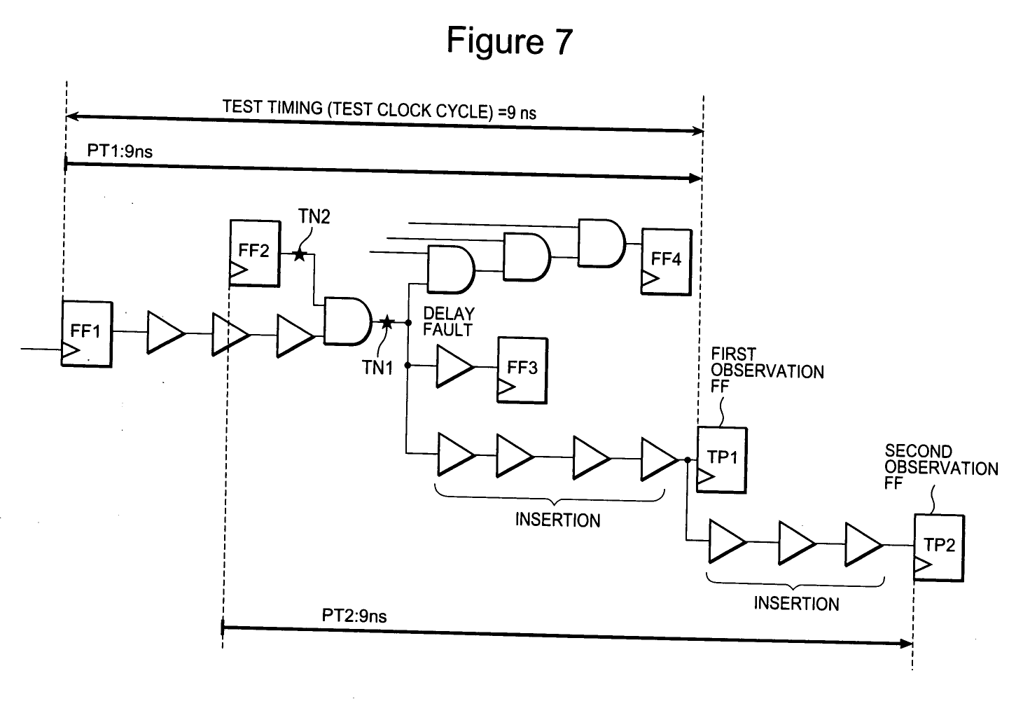

FIG. 7 illustrates a third example of the designed circuit related to the present invention. Description overlapping with description in the already presented examples will be omitted appropriately. For the third example, a plurality of test points TP1 and TP2 are inserted. The first test point TP1 (first observation flip-flop) is inserted in order to detect the small delay defect at the first target node TN1. The path from the flip-flop FF1 to the first test point TP1 is the first test point path PT1. On the other hand, the second test point TP2 (second observation flip-flop) is inserted in order to detect the small delay defect at the second target node TN2. The path from the flip-flop FF2 to the second test point TP2 is the second test point path PT2.

Also in the present example, a predetermined TP delay is designated for each of the first test point path PT1 and the second test point path PT2. For example, as illustrated in FIG. 7, similarly to the second example, the respective TP delays are set so as to be the same as the test clock cycle at the time of the delay test. Otherwise, the respective TP delays can be set so as to be the same as the delay time of the longest path P2.

Also in the present example, the same effects as in the already presented examples are obtained. That is, even if a small delay defect has occurred at the first target node TN1 and the second target node TN2, the small delay defect is not overlooked but is detected normally. In addition, since a plurality of test points are inserted, higher quality delay test is realized. Moreover, as illustrated in FIG. 7, the inverters inserted as the delay elements can be partly shared. That is desirable from the point of view of restraining an increase in area.

### 1-4. Fourth Example

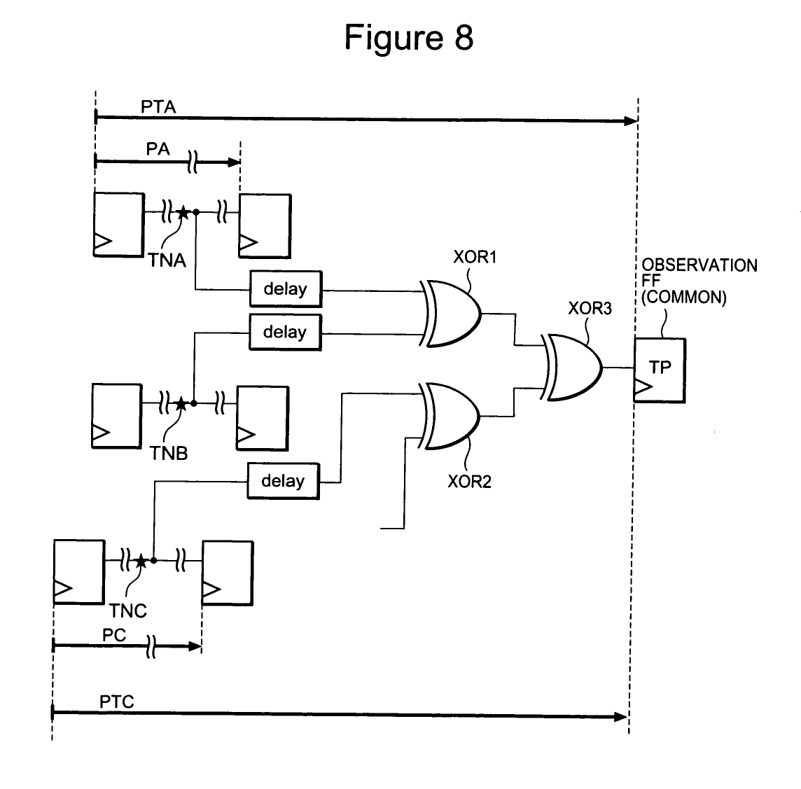

FIG. 8 illustrates a fourth example of the designed circuit related to the present invention. In the fourth example, small delay defects at multiple target nodes (TNA, TNB, TNC and so on) can be detected with one test point TP. That is, one test point TP is shared by the multiple target nodes (TNA, TNB, TNC and so on). Therefore, as illustrated in FIG. 8, one test point TP (observation flip-flop) is connected to the multiple target nodes (TNA, TNB, TNC and so on) through XOR gates (XOR1, XOR2 and XOR3).

Thus, sharing the test point TP with the XOR gates is a known technique. However, according to the present example, TP delay is separately designated for each of a plurality of test point paths connected to the test point TP. For example, the longest path among the paths passing the target node TNA is taken as path PA. At that time, the TP delay on the test point path PTA passing the target node TNA is designated so as to be the same as the delay time of the longest path PA. In addition, the longest path among the paths passing the target node TNC is taken as path PC. At that time, the TP delay on the test point path PTC passing the target node TNC is designated so as to be the same as the delay time of the longest path PC. The respective TP delays of the test point paths PTA and PTC do not necessarily have to be the same but are set to respectively desired values. Otherwise, similarly to the second example, the respective TP delays can be set so as to be the same as the test clock cycle at the time of the delay test.

Also in the present example, the same effects as in the already presented examples are obtained. That is, accuracy in detecting the small delay defect in delay tests is improved. In addition, with the XOR gate, the test point TP is shared. Therefore, the total number of test points TP decreases to reduce circuit area. Moreover, in order to realize a desired TP delay, the delay time of the XOR gate itself can be utilized. That is, a part or all of the inverters inserted as delay elements in the already presented examples will be unnecessary. That means that the circuit configuration for realizing the desired TP delay becomes simple. In other words, the XOR gate in the present example does not only contribute sharing of the test point TP but also contribute to realization of a desired TP delay with a simpler configuration. That is a synergetic effect particular to the present invention, which was not obtainable in the conventional system.

### 1-5. Fifth Example

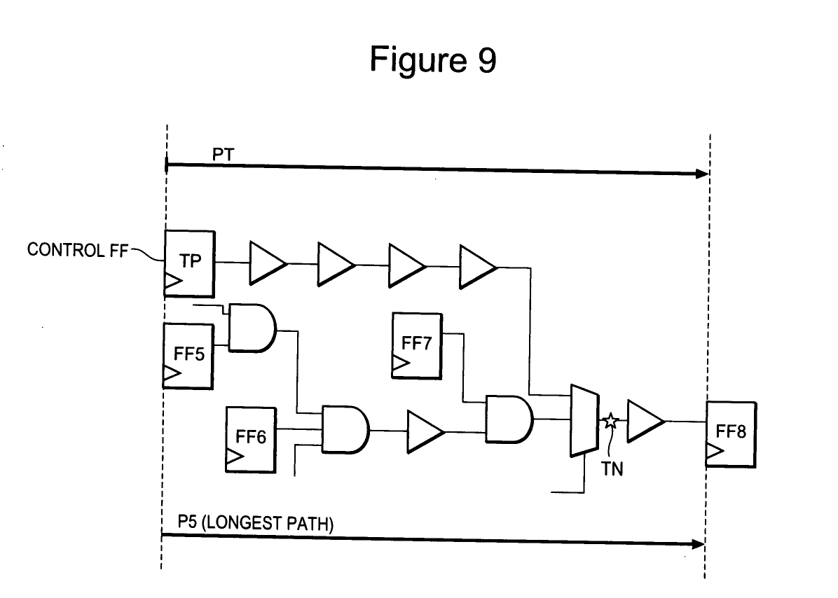

In the above described example, the case of an observation test point was described and the case of the control test point is similar. FIG. 9 exemplifies the case where a control test point is inserted. A designed circuit illustrated in FIG. 9 includes flip-flops (scan flip-flops) FF5 to FF8. In addition, the test point TP (control flip-flop) is inserted into a target node TN. A path from the test point TP to the flip-flop FF8 is the test point path PT. The TP delay is designated for the test point path PT. For example, the TP delay is set so as to be the same as the delay time of the longest path P5 passing the target node TN. Otherwise, the TP delays can be set so as to be the same as the test clock cycle at the time of the delay test.

Here, in the above described first to fifth examples, a certain range not longer than the test clock cycle can be designated as a TP delay for the test point path PT. For example, the TP delay can also be set to a range of 8 ns to 9 ns. Also in that case, the designated TP delay will be the maximum of the delay time of the paths passing the target node TN. Accordingly similar effects are obtainable.

### 2. Design System

A variety of modes are considered as a design system for realizing a design technique related to the present invention.

### 2-1. First Embodiment

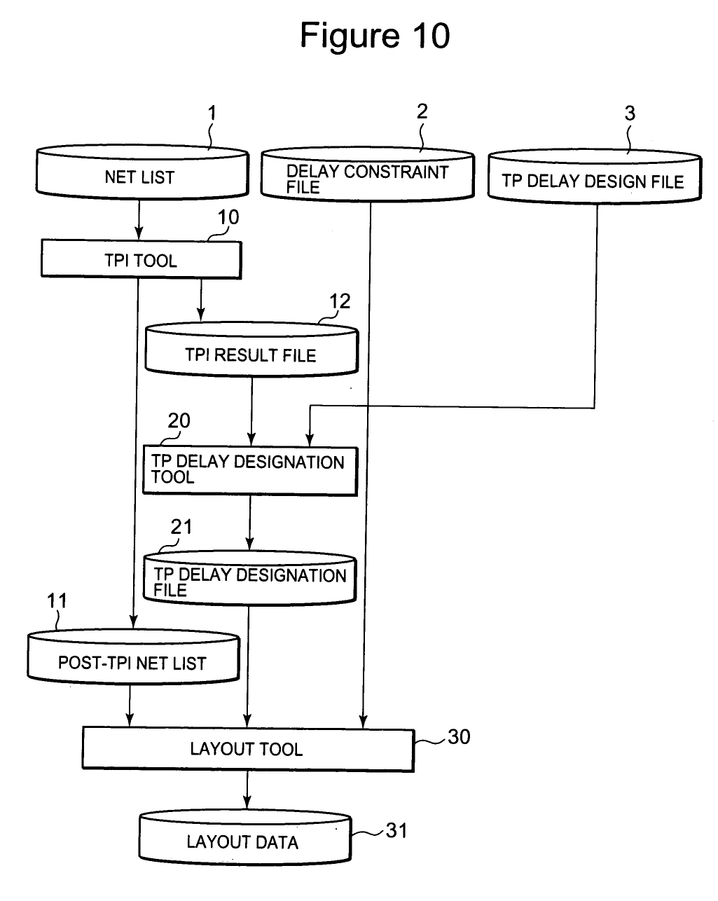

FIG. 10 is a block diagram illustrating a first embodiment of the present invention. In the first embodiment, a TPI tool 10, a TP delay designation tool 20, a layout tool 30 and a various kinds of data are used.

The TPI tool 10 carries out insertion of a test point TP (step S100). Specifically, the TPI tool 10 reads the net list 1 to determine a position (target node TN) where the test point TP should be inserted in a designed circuit designated by that net list 1. The TPI tool 10 inserts a test point TP into a determined insertion position. Consequently, the post-TPI net list 11, where the test point TP is inserted, is prepared. In addition, the TPI tool 10 prepares a TPI result file 12 stipulating the process contents.

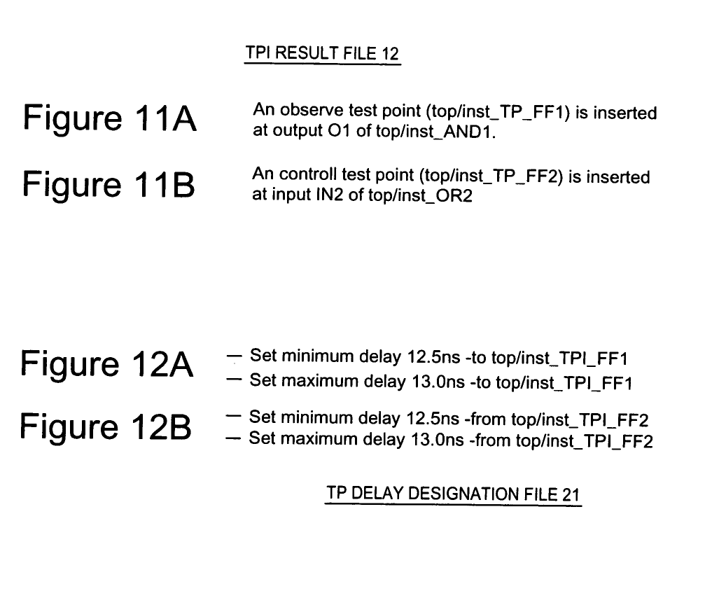

FIG. 11 exemplifies the TPI result file 12. In the TPI result file 12, an instance name of a test point and an insertion site of a test point are described. For example, description (a) in FIG. 11 specifies that an observation test point (instance name: inst_TP_FF1) is inserted into an output of the instance AND1. In addition, description (b) specifies that a control test point (instance name: inst_TP_FF2) is inserted into an input of the instance OR2.

Again with reference to FIG. 10, the TP delay designation tool 20 reads the TPI result file 12 and the TP delay design file 3. A TP delay design file 3 is prepared by a user and is a file in which design strategy is described. In particular, information on TP delay designation is described in the TP delay design file 3. For example, an intention that the TP delay is designated to a test clock cycle is described. The TP delay designation tool 20 prepares a TP delay designation file 21 designating a TP delay based on the TPI result file 12 and the TP delay design file 3 (step S200). The TP delay designation file 21 is a file referred to at the time of subsequent layout process and is described in a format allowing interpretation of the layout tool 30.

FIG. 12 exemplifies the TP delay designation file 21. In the TP delay designation file 21, a command list giving delay constraint to the test point path PT is listed. For example, the command (a) in FIG. 12 is prepared based on the description (a) in the TPI result file 12 illustrated in FIG. 11. Specifically, the command (a) constrains the TP delay of the test point path ending at the observation test point (instance name: inst_TP_FF1) to fall within the range of 12.5 ns to 13.0 ns. On the other hand the command (b) is prepared based on description (b) in FIG. 11. Specifically, the command (b) constrains the TP delay of the test point path starting at the control test point (instance name: inst_TP_FF2) to fall within the range of 12.5 ns to 13.0 ns.

Thus, the TP delay designation tool 20 prepares a TP delay designation file 21 allowing interpretation of the layout tool 30 based on the TPI result file 12 and the TP delay design file 3. Here, instead of the TP delay designation tool 20, a user can prepare the TP delay designation file 21.

Again, with reference to FIG. 10, the layout tool 30 reads the post-TPI net list 11, the TP delay designation file 21 and a delay constraint file 2. Delay constraint file 2 is normally a file specifying delay constraint (setup constraint and hold constraint) on user circuit portions and specifies delay constraint other than the TP delay. To put it other way around, in the present embodiment, besides the delay constraint file 2 used in general, it can be said that a TP delay designation file 21 dedicated to design of the test point TP is prepared.

The layout tool 30 carries out a layout of a designed circuit based on the post-TPI net list 11, the delay constraint file 2 and the TP delay designation file 21 (step S300). Specifically, the layout tool 30 designs layout and timing of the user circuit portions so that the delay constraint specified by the delay constraint file 2 is fulfilled. As for the test point path PT, layout design and timing design are carried out so that the delay time there becomes a TP delay designated by the TP delay designation file 21. Here, the user circuit portion is higher than the test point path PT in priority of the timing design. Thus, layout data 31 specifying the layout of the designed circuit is prepared.

### 2-2. Second Embodiment

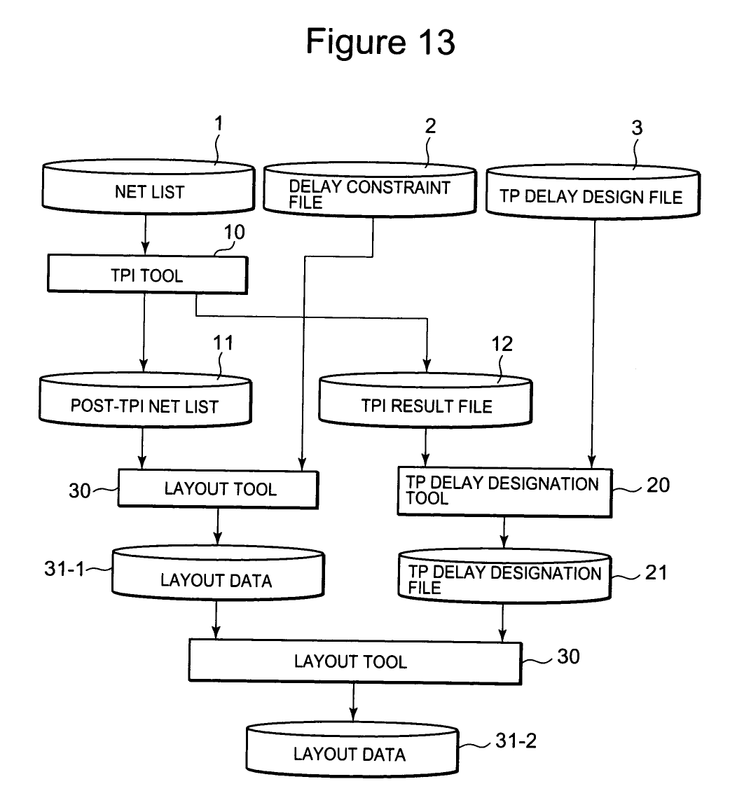

FIG. 13 is a block diagram illustrating a second embodiment of the present invention. Description overlapping with description in the first embodiment will be omitted appropriately. In the second embodiment, a layout tool 30 temporarily carries out layout process based on post-TPI net list 11 and the delay constraint file 2. Consequently, layout data 31-1 in consideration of no TP delay are temporarily prepared. Thereafter, the layout tool 30 carries out layout process again based on the layout data 31-1 and the TP delay designation file 21. At that occasion, only the test point path PT undergoes layout again. Consequently, layout data 31-2 in consideration of TP delay is prepared. According to the second embodiment, influence to the layout in the user circuit portion due to test point insertion is restrained to the smallest level.

### 2-3. Third Embodiment

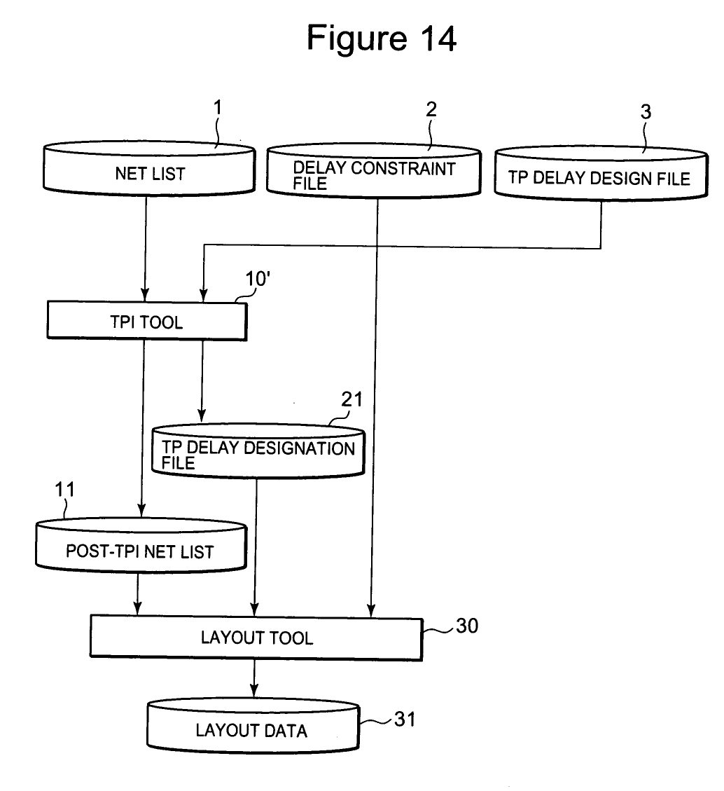

FIG. 14 is a block diagram illustrating a third embodiment of the present invention. Description overlapping with description in the first embodiment will be omitted appropriately. In the third embodiment, a TPI tool 10′ supporting detection of small delay defects is provided. The TPI tool 10′ functions as both of the TPI tool 10 and the TP delay designation tool 20 in the first embodiment. That is, the TPI tool 10′ reads the net list 1 and the TP delay design file 3 to prepare the post-TPI net list 11 and the TP delay designation file 21 (step S100 and step S200). The subsequent processing is similar to that in the first embodiment. According to the third embodiment, the TP delay designation tool 20 becomes unnecessary, which is preferable.

### 2-4. Fourth Embodiment

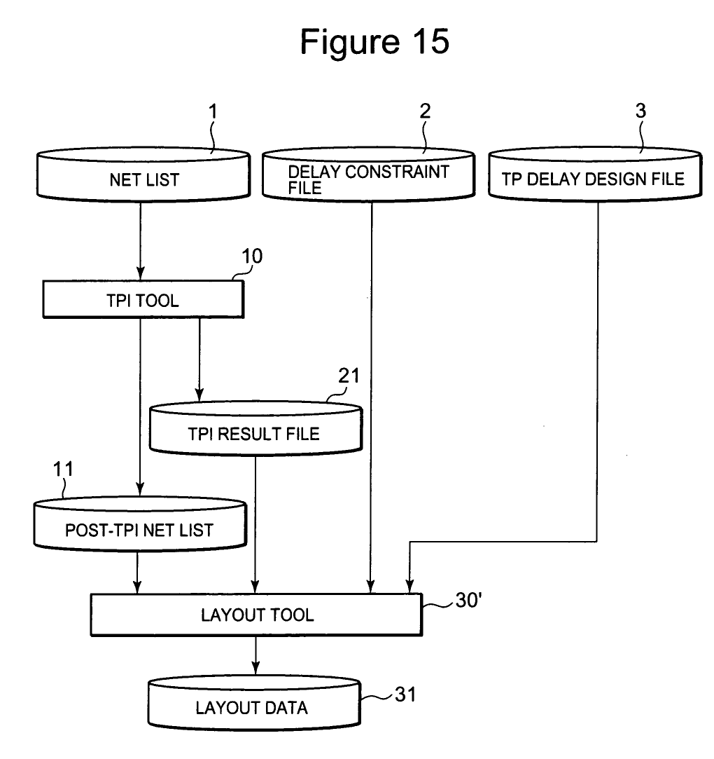

FIG. 15 is a block diagram illustrating a fourth embodiment of the present invention. Description overlapping with description in the first embodiment will be omitted appropriately. In the fourth embodiment, a layout tool 30′ supporting detection of small delay defects is provided. The layout tool 30′ functions as both of the TP delay designation tool 20 and the layout tool 30 in the first embodiment. That is, the layout tool 30′ reads the post-TPI net list 11, TPI result file 12, the delay constraint file 2 and the TP delay design file 3 to prepare the layout data 30.

The layout tool 30′ makes reference to the post-TPI net list 11 and the TPI result file and can recognize the test point TP in the post-TPI net list 11. In addition, the layout tool 30′ can interpret the TP delay design file 3 and recognize a designated TP delay. Moreover, the layout tool 30′ designs layout and timing so that delay time of the path connected to the test point TP becomes a designated TP delay. According to the fourth embodiment, the TP delay designation tool 20 becomes unnecessary, which is preferable.

Here, in the above described embodiment, the TPI tool 10 or the TPI tool 10′ can directly read RTL (Register Transfer Level) description instead of the net list 1. In that case, the TPI tool 10 or the TPI tool 10′ is provided with a logic synthesis function and a TPI function, carries out logic synthesis processing and test point insertion processing at a stroke and thereby prepares the post-TPI net list 11.

### 2-5. CAD System

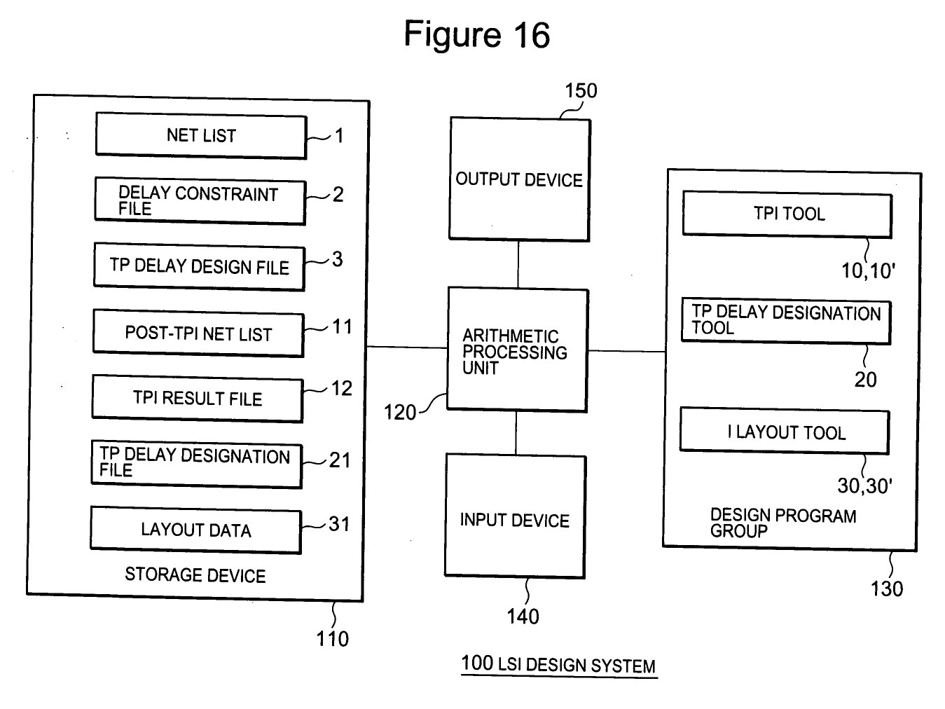

The design systems illustrated in FIG. 10 to FIG. 15 can be built up on a computer. FIG. 16 is a block diagram illustrating a configuration of an LSI design system 100 (CAD system) realized by a computer. The LSI design system 100 comprises a storage device 110, an arithmetic processing unit 120, a design program group 130, an input device 140 and an output device 150.

The storage device 110 is exemplified by a RAM and a HDD. The above described net list 1, delay constraint file 2, TP delay design file 3, post-TPI net list 11, TPI result file 12, TP delay designation file 21, layout data 31 and the like are stored in the storage device 110.

The design program group 130 is stored in storage media allowing a computer to read. The design program group 130 includes the above described TPI tool 10 (10′), TP delay designation tool 20, layout tool 30 (30′) and the like. Those tools are software read and executed by the arithmetic processing unit 120. The arithmetic processing unit 120 executes software hereof and realizes, thereby, design processing of a semiconductor integrated circuit related to the present invention. The arithmetic processing unit 120 reads required data and files from the storage device 110 and stores prepared data and files into the storage device 110.

The input device 140 is exemplified by a keyboard and a mouse. A user can edit files and input commands with the input device 140. The output device 150 is exemplified by a display. The user can make reference to design information such as layout displayed on the display.

### 3. Recapitulation

According to the present invention, a method of designing a semiconductor integrated circuit based on the TPI technique is provided. Accordingly, it will be possible to improve testability with a test point TP. The number of test patterns is reduced as well. In addition, only the portion where the test point TP is inserted influences design of a user circuit portion and there is no need to change timing design on the user circuit portion to a large degree.

Moreover, according to the present invention, unlike a conventional TPI technique, an arbitrary TP delay can be designated actively for the test point path PT. That is, the delay time in the test point path PT can be set to a size sufficient for detecting a small delay defect. Consequently, occurrence of overlooking small delay defects in the delay test decreases dramatically. Accordingly, the rate of defective occurrence on the market is reduced and product reliability increases. Thus, according to the present invention, enhancing the advantages of the conventional TPI technique, accuracy in detecting the small delay defect can be enhanced.

The present invention has been described based on the above examples, but the present invention is not limited only to the above examples, and includes various kinds of alterations and modifications that could be achieved by a person skilled in the art within the scope of the invention of each of claims of this application as a matter of course.

Further, it is noted that, Applicant's intent is to encompass equivalents of all claim elements, even if amended later during prosecution.

What is claimed is:

1. A method of designing a semiconductor integrated circuit, comprising:
inserting a test point into a target node in a circuit; and
designating a delay time for a test point path, said test point path being a path connected to the test point

2. The method according to claim 1,
wherein said delay time is designated to be a maximum of the delay time of among a plurality of paths, including said path, passing the target node.

3. The method according to claim 2,
wherein a maximum delay time among delay times of a plurality of paths, passing a target node, other than the test point path is designated as the delay time of the test point path.

4. The method according to claim 1,
wherein a clock cycle at a time of a delay test is designated as the delay time of the test point path.

5. The method according to claim 2,
wherein a period not longer than a test clock cycle at a time of a delay test is designated as said delay time of the test point path.

6. The method according to claim 1,
wherein the inserted test point is shared by multiple target nodes including said target node in the circuit; and
wherein the delay time is separately designated for each of a plurality of paths connected to the test point through each of the plurality of target nodes.

7. The method according to claim 6,
wherein, when the test point is inserted, the test point is connected to each of the plurality of target nodes through XOR gates.

8. The method according to claim 1, further comprising:
making a layout of the circuit so that the delay time of the test point path becomes the designated delay time.

9. The method according to claim 1,
wherein a delay designation file specifying the designated delay time is prepared, and a layout of the circuit is made by referring to the delay designation file.

10. A design program product storing a design program to cause a computer to execute a design processing of a semiconductor integrated circuit, comprising:
inserting a test point into a target node in a circuit and preparing a net list where the test point is inserted; and
preparing a delay designation file designating a delay time of a path connected to the test point, said delay designation file being referred to at a time of a layout of the circuit specified by the net list.

11. A layout program product storing a layout program to cause a computer to execute a layout process of a semiconductor integrated circuit, comprising:
reading a net list, where a test point is inserted, from a storage device;
reading a test point delay design file designating a predetermined delay time from the storage device; and
recognizing the test point in the net list and making a layout so that a delay time of a path connected to the test point becomes the predetermined delay time designated by the delay design file.

12. The product as claimed in claim 11,
wherein a test point insertion tool produces a post-test point insertion net list and a test point insertion result file, based on the net list.

13. The product as claimed in claim 12,
wherein a test point delay designation tool, responsive to the test point insertion result file and said test point delay design file, produces a test point delay designation file.

14. The product as claimed in claim 13,
wherein a layout tool produces a layout data, based on the post-test point insertion net list, the delay designation file and a delay constraint file.

15. The product as claimed in claim 12,
wherein a first layout tool responsive to the post-test point insertion net list and a delay constraint file, produces a first layout data,
wherein a test point delay designation tool, responsive to the test point insertion result file and a test point delay design file, produces a test point delay designation file, and
wherein a second layout tool, responsive to the first layout data and the test point delay designation file, produces a second layout data.

16. The product as claimed in claim 11,
wherein a test point insertion tool produces a post-test point insertion net list and a test point delay designation file, based on the net list and a test point delay design file, and
wherein a layout tool, responsive to the post-test point insertion net list and the test point delay designation file, and a delay constraint file, produces a layout data.

17. The product as claimed in claim 12,
wherein a layout tool, responsive to the post test point insertion net list, the test point inset result file, a test point delay designation file and a delay constraint file, produces a layout data.
